(19) United States
(12) Patent Application Publication
(10) Pub. No.: US 2017/0195272 A1
(43) Pub. Date: Jul. 6, 2017

(54) METHOD AND DEVICE TO PRESENT CANDIDATE CONTACTS BASED ON PROXIMITY INFORMATION

(71) Applicant: Lenovo (Singapore) Pte. Ltd., New Tech Park (SG)

(72) Inventors: Arnold S. Weksler, Raleigh, NC (US); John Carl Mese, Cary, NC (US); Russell Speight VanBlon, Raleigh, NC (US); Nathan J. Peterson, Durham, NC (US)

(21) Appl. No.: 14/987,940

(22) Filed: Jan. 5, 2016

(51) Int. Cl. H04L 12/58; H04W 4/02; H04W 8/18; G06F 3/0482; H04L 12/18

(52) U.S. Cl. CPC H04L 51/20; G06F 3/0482; H04L 12/1831; H04L 51/043; H04W 8/183; H04W 4/023; H04M 1/72552

(57) ABSTRACT

A computer implemented method and device are provided. The method and device prepare a communications event (CE) through a user interface of a user-related device, access proximity information related to contacts on a contact list and present, on the user interface of the user-related device, a candidate contact to utilize with the communications event based on the proximity information.

### BACKGROUND

Embodiments of the present disclosure generally relate to contact prioritization in connection with communications events.

Today, portable and desktop devices offer various software applications that enable users to maintain and utilize contacts (e.g. an electronic address book) in connection with imitation communication events. The user is afforded the option to enter various types of information regarding each individual contact, including various types of address information (e.g. phone number, email address, physical address). When the user generates a communications event (e.g., text message, email, social media posting, etc.), existing software applications afford limited techniques for designating recipients of the communications event. For example, existing email, text messaging and other communications applications may self-populate the destination “TO” or “CC” field as the user begins to enter destination designators (e.g., phone number, name, email address). As the user enters a destination designator in the TO field, when more than one potential destination matches the information entered by the user, the application offers a list of potential matches.

However, when the email, text or other application, does not offer suggestions, the user either types the full destination designator or must access the user's full contact list to search for the contact associated with the desired destination contact. The user accesses his/her contacts, scrolls through his/her contact list and selects the contact(s) for the recipient(s) to receive the email. As another example, when the user creates a text message on a phone, the user may populate the designation TO or CC field in a similar manner.

However, in many instances, only a small portion of the contact list is relevant based on the present circumstances. For example, when on vacation with friends and family, the user may be interested in sending email or text messages to the people with him/her on vacation. As another example, before, during or shortly after business meetings, the user may wish to send correspondence, documents and/or other information to business colleagues who attended the meeting or are otherwise interested in the content of the meeting. Today, the user still must search his/her complete list of contacts for the friends, family, colleagues, etc., before designating a destination contact. Searching a complete contact list is inconvenient and time consuming.

### SUMMARY

In accordance with embodiments herein, a computer implemented method is provided under control of one or more processors configured with specific executable program instructions. The method prepares a communications event (CE) through a user interface of a user-related device, accesses proximity information related to contacts on a contact list and presents, on the user interface of the user-related device, a candidate contact to utilize with the communications event based on the proximity information.

Optionally, the method further comprises ordering a list of candidate contacts based on the proximity information, wherein the presenting includes presenting the list of candidate contacts in an ordered priority. The preparing includes opening a CE message having a destination field and the presenting includes displaying a list of device destination addresses associated with candidate contacts. The method determines the proximity information based on a user-related location and a contact-related location. The user-related location is associated with a physical location of the user-related device and the contact-related location is associated with a physical location of a contact-related device.

Optionally, the determining includes determining a distance between the user-related location and the contact-related location. The communications event is associated with a user account, the contact list being associated with the user account. The method further comprises determining the proximity information based on a user-related calendar event associated with the user account and a contact-related calendar event associated with the candidate contact. The method may track a contact-related location of the candidate contact and updating the proximity information based on the contact-related location.

In accordance with embodiments herein, a device is provided comprising a processor, a user interface generated via the processor and a memory storing program instructions accessible by the processor. The program instructions are executable by the processor to, prepare a communications event (CE) through the user interface, access proximity information related to contacts on a contact list and present, on the user interface, a candidate contact to utilize with the communications event based on the proximity information.

Optionally, the program instructions are executable by the processor to implement a proximity identifier module and a priority manager module. The proximity identifier module may be configured to determine when a contact-related location associated with one or more contacts on the contact list changes. The priority manager module may be configured to reduce a priority of the one or more candidate contacts based on the change. The program instructions are executable by the processor to implement a proximity identifier module. The proximity identifier module may be configured to determine the proximity information for candidate contacts that have associated contact-related calendar events that correspond to a user-related calendar event.

Optionally, the program instructions are executable by the processor to implement a priority manager module. The priority manager module may be configured to prioritize a list of candidate contacts by increasing a priority of one or more candidate contacts. The program instructions are executable by the processor to implement a CE manager module that is configured to initiate the communications event by opening a text or email application and to present a candidate phone or email address for the candidate contact.

Optionally, the program instructions are executable by the processor to implement a priority manager module configured to monitor past interaction with the candidate contact, and change a rank of the candidate contact based on the past interaction. The memory further stores a list of contacts. The contacts may include corresponding proximity information and one or more candidate device destination addresses. The user interface is configured to display a CE message having a destination field and to display a list of device addresses associated with a list of candidate contacts. The user interface may be configured to receive a selection from the list of candidate contacts. The user interface may populate the destination field with one or more device destination addresses based on the selection from the list of candidate contacts.

In accordance with embodiments herein, a computer program product is provided comprising a non-signal computer readable storage medium comprising computer executable code to perform. The computer program product prepares a communications event (CE) through a user interface of a user-related device, accesses proximity information related to contacts on a contact list and presents, on the user interface of the user-related device, a candidate contact to utilize with the communications event based on the proximity information.

Optionally the computer program product may further comprise determining the proximity information based on a user-related location and a contact-related location. The computer program product further comprises determining the proximity information based on a user-related calendar event associated with the user account and a contact-related calendar event associated with the candidate contact.

### BRIEF DESCRIPTION OF THE DRAWINGS

FIG. 1 illustrates a system that prioritizes contacts based on proximity information in accordance with embodiments herein.

FIG. 2A illustrates a simplified block diagram of a device used in accordance with embodiments herein.

FIG. 2B illustrates examples of software modules that may be implemented through program instructions in connection with the various functions and features as described herein.

FIG. 3 illustrates a process for managing prioritization and presentation of candidate contacts in connection with preparing a communications event in accordance with embodiments.

FIG. 4A illustrates a process for determining proximity information based on stored addresses in a contact list, in accordance with embodiments herein.

FIG. 4B illustrates a process for determining proximity information based on physical coordinates of a user device and candidate contacts in accordance with embodiments herein.

FIG. 4C illustrates a process for determining proximity information based on correlation between calendar events for the user and contacts in accordance with embodiments herein.

FIG. 5 illustrates a screenshot of an example for a communications event associated with an electronic mail message presented in accordance with an embodiment herein.

FIG. 6 illustrates a screenshot of an example of a communications event associated with a text message presented in accordance with an embodiment herein.

### DETAILED DESCRIPTION

It will be readily understood that the components of the embodiments as generally described and illustrated in the FIGS. herein, may be arranged and designed in a wide variety of different configurations in addition to the described example embodiments. Thus, the following more detailed description of the example embodiments, as represented in the FIGS., is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “contact” includes, but is not limited to, a record, file or collection of electronic information identifying an individual source or destination with which a communications event may occur. By way of a non-limiting example, a contact may include one or more phone numbers, email addresses, individual/business names, and/or any other identification information uniquely associated with a source/destination for communications events. The source and/or destination may designate one or more device, account, individual, group, business, association and the like. The contact may also include additional information, regarding the source/destination (e.g. family names, history, notes, etc.). The contact may include alphanumeric text, audio files, video files, photographs, hypertext links and the like. As explained herein, one or more of the contacts include (or have associated therewith) proximity information that is utilized, maintained and updated as explained herein.

The terms “contact list” and “contact account” refer to a group of one or more contacts that are maintained by a contact management software package in connection with, and/or stored together, as a common account, such as for an individual user, business, association, group and the like.

The term “communications event” or “CE”, as used throughout, shall generally refer to any type of communication supported by electronic devices and/or electronic accounts. For example, a communications event may correspond to an electronic mail message, a text message, a phone call, social media messages, as well as any general type of communication conveying documents, audio content, video content or other electronic content to a destination address. For example, the communications event may represent conveyance of information, content, data and the like utilizing one or more of various existing services, such as the Google Drive™ file storage and synchronization service, the Dropbox™ file storage and synchronization service, the SkyDrive™ file storage and synchronization service, Facebook, Instagram, Skype, Twitter, and the like. Other types of communications events may be supported by various social media, public and private networks and the like.

The terms “communications content”, as used throughout, shall generally refer to any and all textual, audio or video information or data conveyed to or from a device during a communications event. The communications content may be as simple as a telephone number for an incoming or outgoing phone call, or may be more extensive, such as the complete data content (including addressing headers) for an individual or string of email messages, text messages and the like. The communications content may include notes, task information, text messages, email messages, picture(s), audio, video and media files.

The terms “user” and “user-related”, as used herein, shall refer to information, data, locations, calendar events, content and the like that are associated with a user account or user device for an individual or entity preparing opening, creating, or otherwise utilizing a communications event.

The term “contact-related”, as used herein, shall refer to information, data, locations, calendar events, content and the like that relate to contacts on the contact list of a user or user-related account or device.

In accordance with embodiments herein, methods and systems are provided that maintain proximity information in connection with contacts of a user account or user device. The proximity information is used to facilitate preparation of communications events in connection with the user account or user device. For example, when creating an email or text message, the proximity information is utilized to identify a subset of the overall contact list that is more likely to be relevant to the email or text message. The proximity information is used to reorder the contact list as presented to the user, where contacts having a higher rank (also referred to as having local proximity) are presented higher on a search order of the contact list, while contacts having a lower rank (also referred to as having remote proximity) are presented lower on the search order of the contact list. As one example, when the user desires to select a contact from a Facebook user account, the contacts within the Facebook user account are reordered such that “friends” that have local proximity are presented first within the contact list.

In accordance with embodiments herein, the proximity information may be based upon various criteria, as well as combinations of such criteria. For example, the proximity information may be based upon one or a combination of stored addresses, present physical locations, calendar events, contact classifications, time of day, day of the week, and the like. A distance between a user and a contact may be used to refine a contact rank in a candidate list (e.g. when presenting a list of candidate contacts while creating an email, text message or other communications event). For example, when a contact is in a same house as a user, the contact may be assigned a high rank. When a contact is in the same city as a user, the contact may be assigned a rank lower, relative to contacts in the same house.

The proximity information may designate various levels of relative priority. For example, the proximity information may simply distinguish between local and remote contacts. Alternatively, the proximity information may have multiple levels of priority (e.g. ranging over a scale, such as 1 to 10). Alternatively, the proximity information may be calculated as a specific value in connection with each individual contact (e.g. a physical distance between the user and the contact).

In accordance with embodiments herein, the proximity information may be updated as desired to track current locations of the user and/or the contact. For example, a contact may normally live in a remote location (e.g. another state), but the contact may temporarily be near or local to the user. When a contact is near or local to a user, embodiments of the methods and systems herein update the proximity information to increase the likelihood/ranking for the corresponding contact. When the contact leaves the user's general location, the contact rank is then reduced. Optionally, a time delay may be introduced following departure of the contact before the contact rank is reduced. For example, when a family member leaves home and returns to college, the contact for the family member may maintain a local proximity rank for a few days after the contact has returned to college. As another example, after a vacation, the friends and family that were classified as local during the vacation may remain classified as local for a few days thereafter, in the event that the user wishes to convey photos and follow-up content to the friends and family.

Optionally, the methods and systems herein may learn a user's historic interaction with contacts and increase a particular contact rank depending upon the past interaction. For example, the past interaction may indicate that a user sends text messages to a particular contact each time the contact is in a same city as the user. The methods and systems learn/remember the historic interaction, and the next time the user and contact are in the same city, the rank of the contact is increased. Optionally, ranking contacts based on historic interaction need not be limited solely to when the user and contact are in the same city. Instead, historic interaction can be utilized to re-rank contacts based on various criteria, such as when the user and contact are in a common geographical area and/or when the user and/or contact are in certain types of geographic areas (e.g. a vacation destination, at a user/contacts home address, etc.). Optionally, the contact ranking may be updated in connection with business meetings that a user and/or a contact attend. For example, when a user and contact attend a common meeting, the contact may be assigned a higher rank. The proximity of the contacts to the user during a meeting may be determined from physical location information, calendar entries, direct wireless communication between a user-related device and a contact-related device, and the like. Next, various embodiments are described

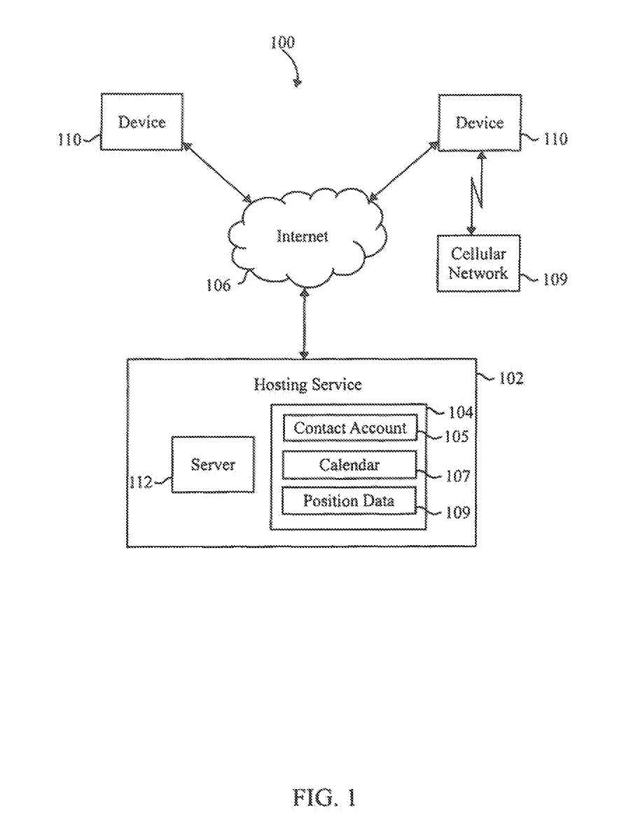

FIG. 1 illustrates a system 100 that prioritizes contacts based on proximity information. The system 100 includes one or more electronic devices 110 that communicate through various communications medium such as over the Internet 106, a cellular network 109 and the like. The devices 110 may represent computing devices, electronic devices and/or other types of devices that perform the operations described herein.

A hosting service 102 may include one or more remote storage medium (also referred to as cloud storage) 104 that are operatively coupled to one or more servers 112. The servers 112 manage communication between devices 110 and between users, where the communications occur over a cellular network, the Internet 106 or other network configured to convey communications content. The hosting service 102 performs various operations in connection with establishing and maintaining communications events between devices 110, as well as maintaining one or more contact accounts 105 calendars 107, position data 109 and the like, associated with a user and/or one or more devices 110 in connection with a contact management software package.

An individual user may have one or more contact accounts 105 and one or more calendars 107 that are maintained at the hosting service 102. By way of example, each contact account 105 may comprise a plurality of contact records, where each contact record is associated with an individual contact. Each calendar 107 includes a plurality of calendar events. A contact account 105 and calendar 107 may be accessible by one or more devices 110. The devices 110 may store, in memory therein, a duplicate copy of the contact account 105 and calendar 107, which is synchronized periodically with the contact account 105 and calendar 107 held at the remote storage medium 104. Once a contact file associated with an individual contact, within the contact account 105, is uploaded to a shared folder on the hosting service 102, anyone (or any device 110) with permission may be granted access to the contact file. Or calendar For example, the hosting service 102 may represent one or more of various existing services, such as the Google Drive™ file storage and synchronization service, the Dropbox™ file storage and synchronization service, the SkyDrive™ file storage and synchronization service and the like. As explained in accordance with embodiments herein, the server 112 and/or devices 110 enables preparation and conveyance of communications events in which communications content is passed to and from various user-related and contact related devices 110.

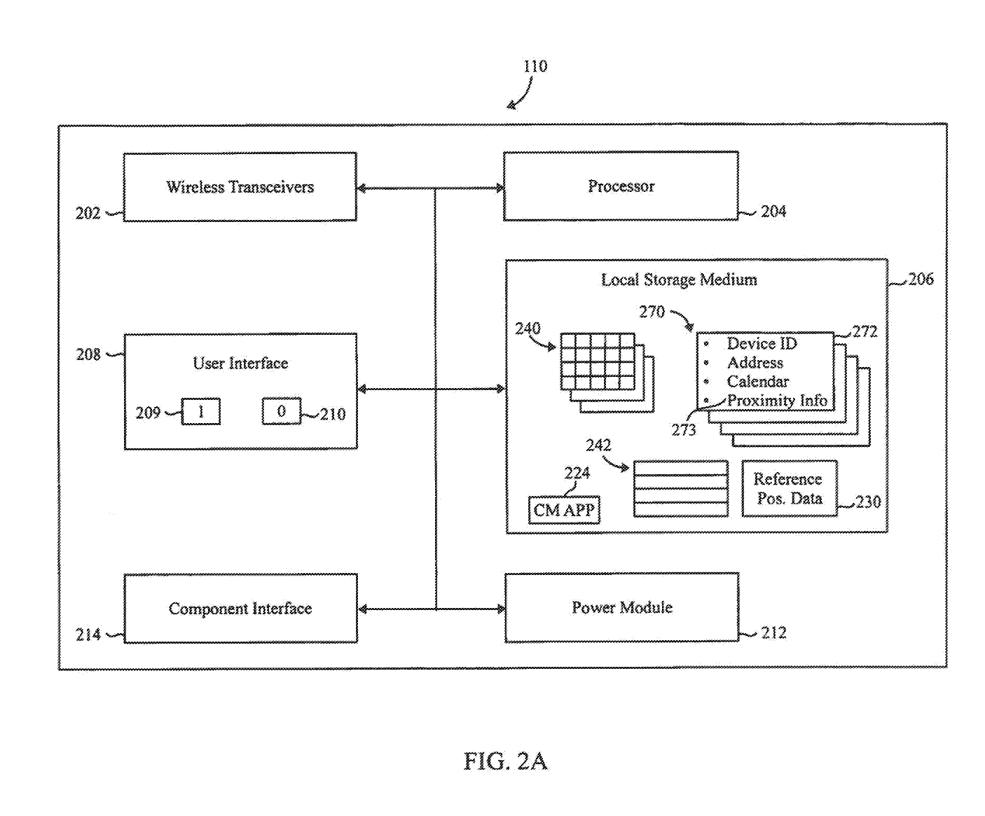

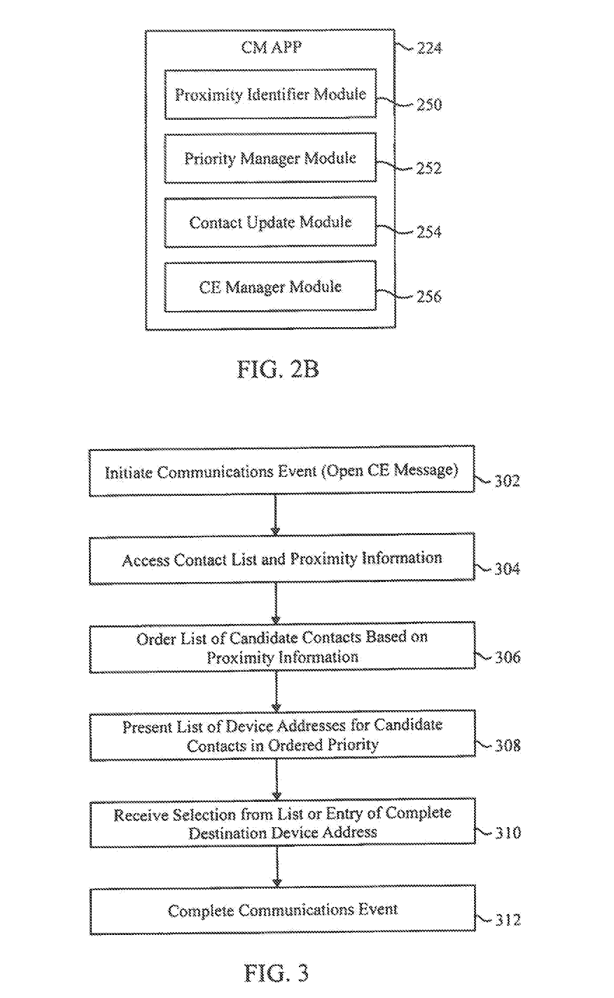

FIG. 2A illustrates a simplified block diagram of a device 110, which includes components such as one or more wireless transceivers 202, one or more processors 204 (e.g., a microprocessor, microcomputer, application-specific integrated circuit, etc.), one or more local storage medium (also referred to as a memory) 206, a user interface 208 generated via the processors 204. The user interface 208 includes one or more input devices 209 and one or more output devices 210, a power module 212, and a component interface 214. All of these components can be operatively coupled to one another, and can be in communication with one another, by way of one or more internal communication links, such as an internal bus.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof.

The user interface 208 permits the user to select one or more of a switch, button, touch area, or icon in connection with various operations of the device 110. By way of example only, the user interface 208 may be used to initiate an outgoing communications event, accept an incoming communications event, scroll through candidate contacts, add/create a new contact, modify an existing contact, create calendar events, delete/review/modify calendar events, select a candidate contact, create or modify candidate position data associated with an individual contact, create or modify reference position data, add or delete devices associated with a user account or candidate contact and the like. As one example, to initiate an outgoing communications event, the user may open a new text message or email message, after which the device 110 enables the user to choose whether the user wishes to identify an existing candidate contact(s) as the destination for the outgoing text or email message. The user may enter an input indicating a desire to select from a list of existing contacts, such as in response to various prompts through entry from soft keys, hard keys, voice commands and otherwise.

Optionally, the user may enter an indication to be prompted with candidate contacts without any prior prompt from the device 110. For example, a user may select a contact list option on the user interface 209, thereby instructing the device 110 to open the contact list and display one or more candidate contacts. In accordance with embodiments herein, the candidate contacts may be displayed in an ordered list that is prioritized based on proximity information.

Optionally, the user may perform certain actions to differentiate between sorting the contact list in a standard manner (e.g., alphabetically based on name, etc.) and sorting the contact list based on proximity information. For example, a contact list icon may be held down for a predetermined longer extended period of time (or double tapped), that is interpreted as an indication to sort the contact list based on proximity information. As another example, the user may enter one or more predefined touch gestures and/or voice commands through a microphone on the device 110. The predefined touch gestures and/or voice commands may instruct the device 110 to utilize proximity information to sort the candidate contact list.

The local storage medium (memory) 206 can encompass one or more memory devices of any of a variety of forms (e.g., read only memory, random access memory, static random access memory, dynamic random access memory, etc.) and can be used by the processor 204 to store and retrieve data. The data that is stored by the local storage medium 206 can include, but is not limited to, operating systems, applications, contacts, contact lists, contact accounts, communications content and other information. Each operating system includes executable code that controls basic functions of the communication device, such as interaction among the various components, communication with external devices via the wireless transceivers 202 and/or the component interface 214, and storage and retrieval of applications and data to and from the local storage medium 206. Each application includes executable code that utilizes an operating system to provide more specific functionality for the communication devices, such as file system service and handling of protected and unprotected data stored in the local storage medium 206.

The local storage medium 206 stores, among other things, a contact list 270 that includes one or more contacts 272. The contacts 272 may include various types of information, such as one or more addresses associated with an individual, one or more telephone numbers, email addresses, job titles, contact classifications (e.g. family, friend, management, client). The contacts 272 may also include destination designators that enable a direct connection with a device (e.g. Bluetooth connection information, hotspot sharing information, etc.). The destination designators (also referred to as device identifiers) may additionally or alternatively include network address designators, such as an IP address, MAC address and the like. The contacts 272 also include proximity information 273 that is generated and updated as described herein.

The local storage medium 206 may also include a calendar 240 for the user. The calendar 240 includes calendar events comprising various information, such as the time, date and location of the event, the type/nature of the event (e.g. management meeting, business, client meeting, family event, vacation), additional individuals that are invited to the event (invitees) and the like.

The local storage medium 206 also includes reference position data 230. The nature of the reference position data 230 may vary depending upon the manner by which proximity information is to be calculated. For example, the reference position data 230 may include a stored address (e.g. home, business, vacation destination). Additionally or alternatively, the reference position data 230 may include physical coordinates associated with a present or recent position of a user device, such as GPS coordinates. Additionally or alternatively, the reference position data 230 may include a calendar event (e.g., Sunset Conference Room at 2:00 PM on Nov. 13, 2015).

The local storage medium 206 also stores a contact management (CM) application 224 for managing preparation, review, etc., of communications events. The CM application 224 calculates proximity information, selects candidate contacts as well as managing contacts, communications content, and operation of the device 110 in order to allow a user to read, create, edit, delete, organize or otherwise manage the calendars, contacts and communications events. The CM application 224 may be activated by default upon start-up of the device 110, and/or may be activated or disabled via input devices 209 of the user interface 208. The CM application 224 may be activated when one or more other applications are opened/activated on the device 110, such as when opening a text messaging application, an email management application, a telephone communications application, entering a Facebook account, reviewing the Twitter posting, and the like. The CM application 224 includes program instructions accessible by the one or more processors 204 to direct a processor 204 to implement the methods, processes and operations described herein including, but not limited to the methods, processes and operations illustrated in the FIGS. and described in connection with the FIGS.

Other applications stored in the local storage medium 206 include various application program interfaces (APIs), some of which provide links to/from the cloud hosting service 102. The power module 212 preferably includes a power supply, such as a battery, for providing power to the other components while enabling the device 110 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

Each transceiver 202 can utilize a known wireless technology for communication. Exemplary operation of the wireless transceivers 202 in conjunction with other components of the device 110 may take a variety of forms and may include, for example, operation in which, upon reception of wireless signals, the components of device 110 detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 210. Likewise, for transmission of wireless signals, the processor 204 formats outgoing information, and conveys the outgoing information to one or more of the wireless transceivers 202 for modulation to communication signals. The wireless transceiver(s) 202 convey the modulated signals to a remote device, such as a cell tower or a remote server (not shown).

The memory 206 stores various types of content elements, such as text messages, email messages, phone logs and the like. The content elements include at least one of incoming communications (IC) content received by a device or outgoing communications (OC) content sent from the device. The memory 206 also stores a log 242 that tracks interaction between users and contacts, such as in connection with learning historic interaction behavior. The log 242 may maintain various criteria, such as the location and time of day in which communications events were exchanged, as well as the individual contacts with whom the communications were exchanged. The log 242 records a list of CE identifiers associated with incoming and/or outgoing communications events and a count of the number of times CE identifier was used. Each CE identifier on the list is associated with a corresponding content element (e.g. text message, email message, phone log, etc.). The priority manager module 252 updates the log 242 each time a new CE is tracked.

FIG. 2B illustrates examples of software modules that may be implemented through program instructions within the CM application 224 in connection with the various functions and features as described herein. By way of example, the CM application 224 may include software modules that include a proximity identifier module 250, a priority manager module 252, a contact update module 254 and a CE manager module 256.

The proximity identifier module 250 determines proximity information, as explained herein, based upon various types of reference data and candidate data. For example, the proximity identifier module 250 may be configured to determine the proximity information based on a user related location and a contact-related location. The user related location may be associated with a physical location of a user-related device. As another example, the user related location may correspond to a stored address. The contact-related location may be associated with a physical location of a contact-related device (e.g., a device identified in the contact by phone number or otherwise). As another example, the contact-related location may be associated with an address stored in the corresponding contact. The proximity identifier module 250 may determine the proximity information by calculating a distance between the user related location and the contact-related location.

Additionally or alternatively, the proximity identifier module 250 may be configured to determine the proximity information based on calendar events, event types, contact types and the like. For example, the proximity identifier module 250 may review calendar events in the calendar for the present user. From the present user's calendar, the proximity identifier module 250 may identify individuals invited to a calendar event. Individuals invited to a calendar event may be designated to have an “local” proximity, while all other members of the contact list are designated to have “remote” proximity. As another example, the proximity identifier module 250 may review the general nature of the calendar event (e.g. management meeting, family vacation, etc.). Based on the nature of the calendar event, different contacts may be assigned local or remote proximity information. For example, when an event is classified as a client meeting, contacts that are classified as clients may be assigned local proximity information, while contacts that are not classified as clients may be assigned remote proximity information. As other examples, a calendar event may be classified as a family event/vacation or a business/management meeting. During a family event/vacation, contacts that are classified as family and friends may be assigned local proximity information. During business/management meetings, contacts that are classified as colleagues and management may be assigned local proximity information. The local proximity designation may remain for a select period of time following completion of the event.

Additionally or alternatively, the proximity identifier module 250 may have access to the calendars for candidate contacts. When the proximity identifier module 250 has access to the calendars of contacts, the proximity identifier module 250 may compare calendar events on the present user's calendar with calendar events of the candidate contacts. The proximity identifier module 250 may determine which candidate contacts have associated contact-related calendar events that correspond to a calendar event for a user (also referred to as a “user-related calendar event”).

The proximity identifier module 250 may calculate the proximity information to have various levels of relative priority. For example, the proximity information may simply distinguish between local and remote contacts. Alternatively, the proximity information may have multiple levels of priority (e.g. ranging over a scale, such as 1 to 10). Alternatively, the proximity information may be calculated as a specific value in connection with each individual contact (e.g. a physical distance between the user and the contact).

The proximity identifier module 250 and priority manager module 252 may be activated periodically or based on various criteria. The proximity identifier module 250 and priority manager module 252 may periodically search for contact-related devices for all or a subset of the contact list. For example, proximity information associated with contacts designated as family members may be updated more frequently, relative to other types of contacts. Additionally or alternatively, proximity information and priority may be updated when a user device interacts with a contact-related device. For example, when a user device receives an email or text message from a contact-related device of a family member, the proximity identifier module 250 and priority manager module 252 may update the proximity information and priority.

A contact may normally live in a remote location (e.g. another state), but the contact may temporarily be near or local to the user. When a contact is near or local to a user, the proximity information is updated to increase the likelihood/ranking for the corresponding contact. When the contact leaves the user's general location, the contact rank is then reduced. Optionally, a time delay may be introduced following departure of the contact before the contact rank is reduced (e.g., when a family member leaves home and returns to college, the contact for the family member may maintain a local proximity rank for a few days after the contact has returned to college). As another example, after a vacation, the friends and family that were classified as local during the vacation may remain classified as local for a few days thereafter, such as in the event that the present user wishes to convey photos and follow-up content to the friends and family.

The proximity identifier module 250 may calculate the proximity information based upon various criteria, as well as combinations of such criteria. For example, the proximity information may be based upon one or a combination of stored addresses, present physical locations, calendar events, contact classifications and the like. A distance between a user and a contact may be used to refine a contact rank in a candidate list (e.g. when presenting a list of candidate while creating an email, text message or other communications event). For example, when a contact is in a same house as a user, the contact may be assigned a high rank. When a contact is in the same city as a user, the contact may be assigned a rank lower, relative to contacts in the same house.

Optionally, various combinations of the criteria may be utilized to reorder contacts. For example, the time of day or physical location they be utilized in combination with different types of contacts. For example, at certain times of day certain types of contacts may be more relevant, while at other times a day other types of contacts are more relevant. For example, during working hours on work days, business related contacts they be more relevant than personal contacts. Similarly, on weekends or during evening hours, the contacts of family and friends may be more relevant. As another example, when a user (as determined through the location of a user related device) is at their place of business, business contacts may be more relevant. When the user is at home, the contacts of family and friends may be more relevant. The combination of the criteria may vary.

The priority manager module 252 orders a list of candidate contacts based on the proximity information such that the list of candidate contacts are presented in an ordered priority. The priority may be based on various criteria. For example, the priority may assign a higher rank to candidate contacts that are located physically closer to the user (e.g. having a local distance), while assigning a lower ranked to candidate contacts that are physically located remote from the user (e.g. having a remote distance).

All or a portion of the list of candidate contacts may be presented on a user interface of the device to the user in connection with various operations. For example, the user may simply wish to view the contact list sorted based on the proximity information, independent of and separate from creation or preparation of a communications event. For example, the user may open their contact list and select an icon or other entry to request the list to be resorted based on the proximity information. Optionally, all or the portion of the contact list may be presented in a drop-down menu during preparation of the communications event.

Optionally, the CM application 224 may be configured to “learn” a user's historic interaction with various contacts and increase a particular contact rank depending upon the past interaction. For example, the priority manager module 252 may track interaction between a user account and/or user device, and the contacts within a contact list. For example, the priority manager module 252 may maintain a log identifying the various criteria utilized for calculating proximity information, as well as communications event behavior exhibited by the user. For example, the log may record that, when the user is in certain cities or certain geographic areas, the user engages in a relatively larger volume of communications events with certain contacts. As another example, the log may record that, during certain time periods (e.g. holidays, weekends, certain days of the week or certain times of day), the user engages in more frequent communications events with certain contacts. For example, during holidays, weekends and evenings, the user may engage in more text messaging with family contacts. As another example, during certain time periods during the business week, the user may engage in more email communication with certain colleagues, service providers, customers, clients and the like.

The priority manager module 252 utilizes the past interaction to remember the historic interaction, such that the next time the corresponding criteria occur, the rank of the contact is increased. For example, when the user and contact are in the same city, the rank of a contact may be increased. The historic interaction recorded by the priority manager module 252 may be utilized to re-rank contacts based on various criteria, such as when the user and contact are in a same area and/or when the user and/or contact our in certain areas (e.g. a vacation destination, at a user/contacts home address, etc.). Optionally, the contact ranking may be updated in connection with business meetings that a user and/or a contact attend. For example, when a user and contacts attend a common meeting, the contact may be assigned a higher rank. The proximity of the contacts to the user during a meeting may be determined from physical location information, calendar entries, direct wireless communication between a user device and a contact-related device, and the like.

The contact update module 254 updates the content of contacts on the contact list. For example, the contact update module 254 may update various fields, including but not limited to contact name, address, device addresses, as well as proximity information that is calculated and updated as explained herein.

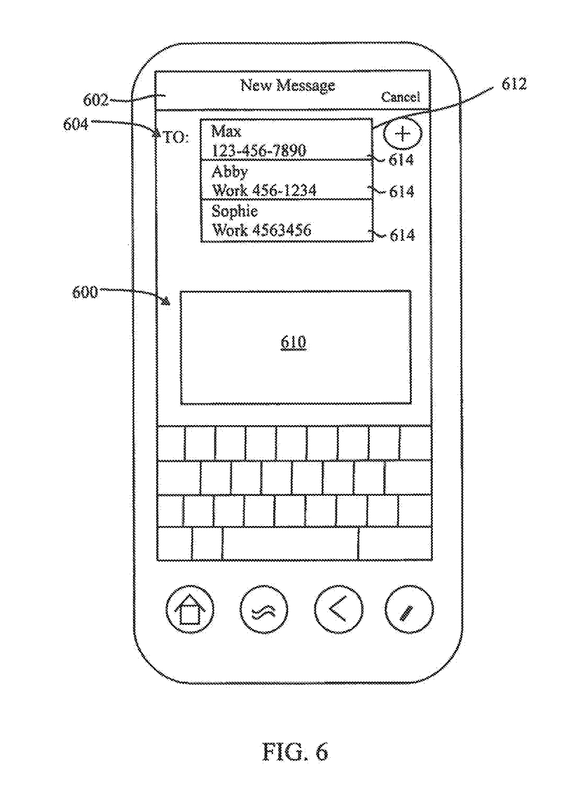

The proximity identifier module 250 is configured to determine when a contact-related location associated with one or more contacts on a contact list changes from a local distance to a remote distance. The CE manager module 256 manages overall operation of communications events through the user interface of a user device, including preparation of communications events, opening and replying to incoming communications events and the like. For example, the CE manager module 256 may initiate a communications event by opening an email message window or text message window (e.g. as illustrated in FIGS. 5 and 6).

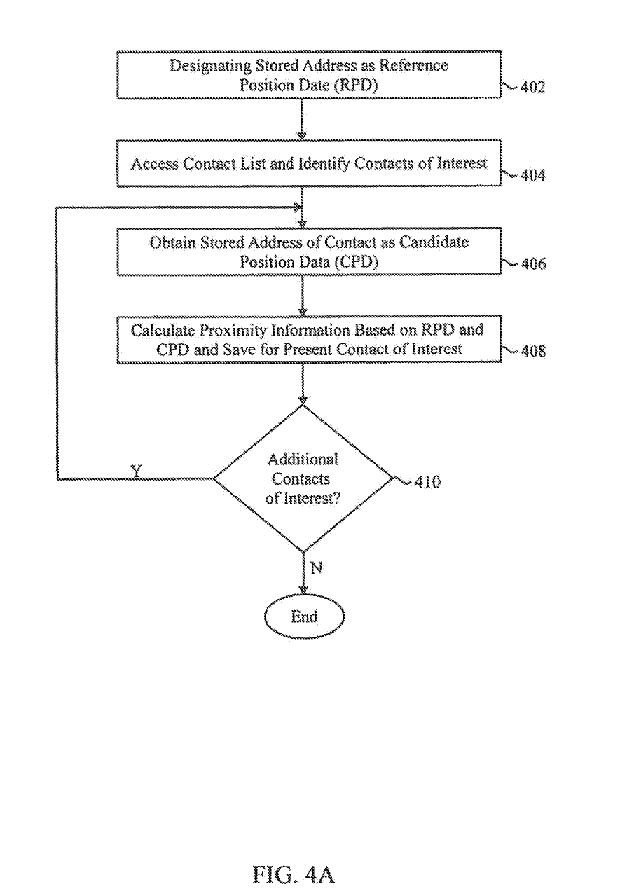

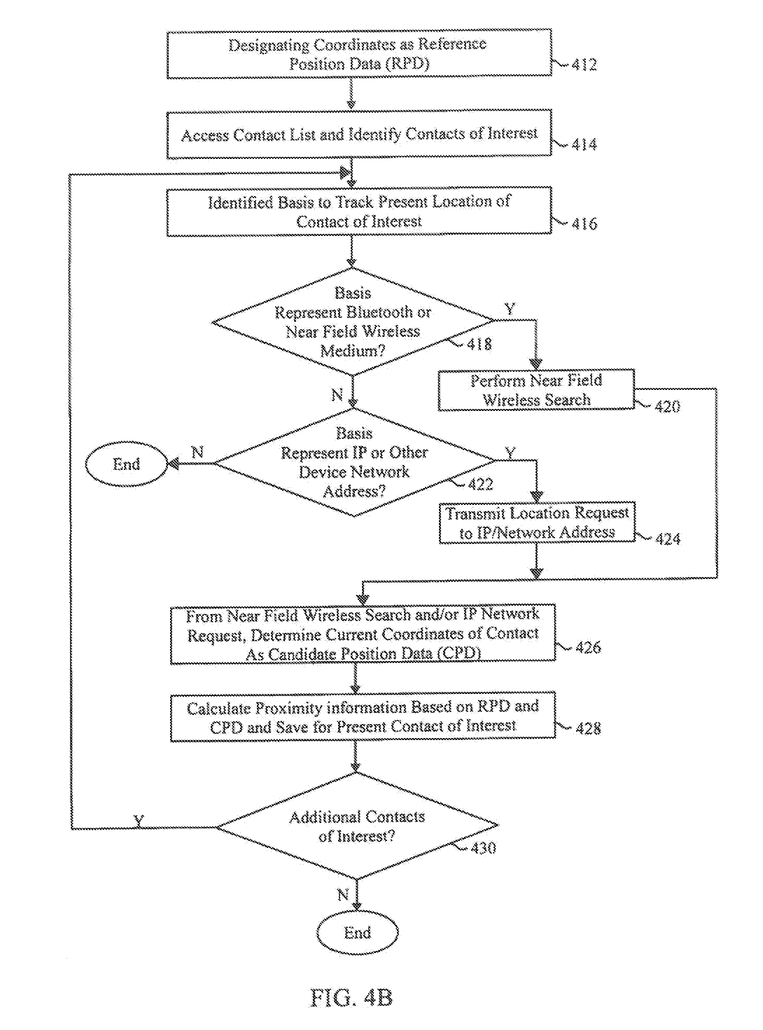

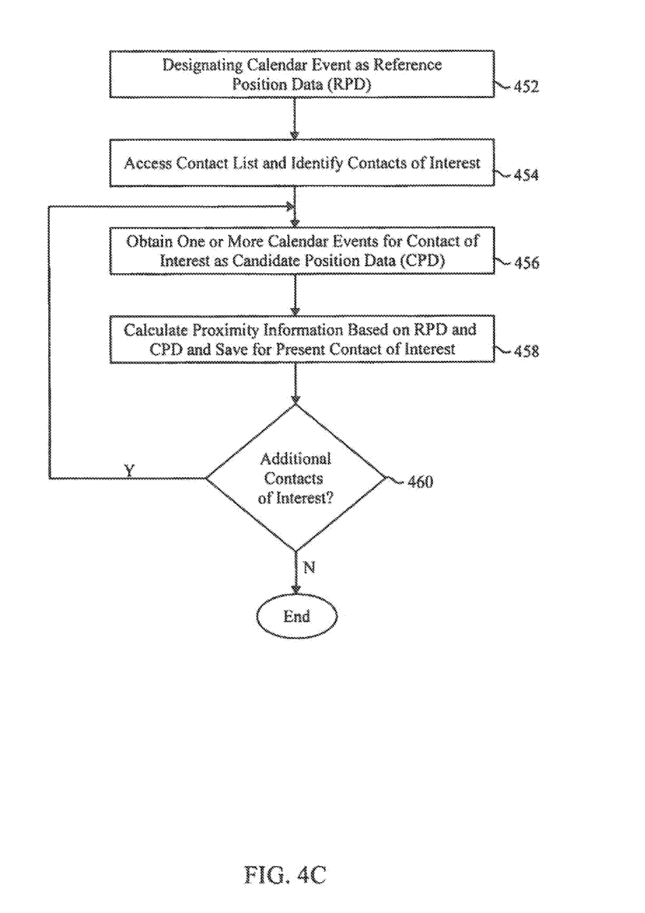

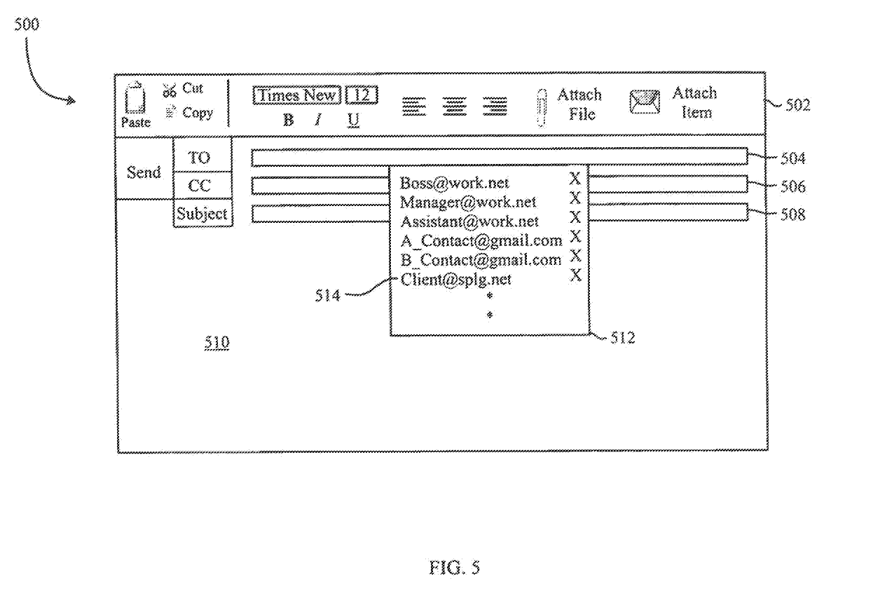

Specific reference will now be made here below to FIGS. 3 and 4. It should be clearly understood that the various arrangements and processes broadly described and illustrated with respect to the FIGS., and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

FIG. 3 illustrates a process for managing presentation of candidate contacts in connection with preparing a communications event in accordance with embodiments. The operations of FIG. 3 are carried out by one or more processors 204 of the device 110 in response to execution of program instructions, such as in the CM application 224, and/or other applications stored in the local storage medium 206. Additionally or alternatively, the operations of FIG. 3 may be carried out by the processors within one or more servers 112 in response to execution of program instructions, such as in the CM application 224 stored at the server, and/or other applications stored at the server. The contact list 270 may represent a list of contacts maintained i) on a single device, ii) in connection with a single user's account on a network, iii) in connection with one or more contact accounts maintained on one or more devices for a common user, iv) in connection with one or more contact accounts maintained by a business, association or other group, or otherwise.

At 302, the processor prepares a communications event (CE) through a user interface of a device under the direction of the user. Various examples of devices are described herein, including, but not limited to, a mobile device, a desktop computer, and the like. The CE may represent an outgoing text message, email message, FaceTime call, twitter message, Facebook posting, audio call or any other type of communication. The preparation of the communications event may represent various activities, depending upon the type of communications event. For example, initiating a communications event may correspond to opening a new email, opening a new text message, replying to an email or text, and the like. Preparing a communications event includes, among other things, designating a destination address for the communications event, as well as entering or selecting content to be included with the communications event. As another non-limiting example, preparing a communications event may also include replying to a prior incoming communication.

At 304, the processor accesses a contact list. For example, the contact list may be associated with a current user account, stored on a device or in connection with a network resource (e.g. a network account), and the like. The processor also accesses proximity information associated with one or more contacts within the contact list. The proximity information may be stored with the corresponding contact. Additionally or alternatively, the processor may calculate new proximity information associated with each contact at 304, based on various data, such as reference position data, candidate position data, calendar events and the like.

At 306, the processor orders a list of candidate contacts based on the proximity information. The ordered list of candidate contacts may represent all or a subset of the contacts within the contact list. As one example, the ordered list may represent a subset, such as the five, 10 or more contacts having the highest rank.

At 308, the processor presents all or a portion of the list of candidate contacts through the user interface on the device. The candidate contact information presented may represent a list of device addresses for candidate contacts from the ordered list. Additionally or alternatively, the candidate contact information may include contact name, contact credentials (e.g. email address, phone number, social media ID) and the like. The candidate contact information may be presented in various manners, such as through a pop-up window overlaid upon a message being created in connection with the communications event. For example, when the communications event represents an email message or text message, the candidate contact information may be presented in a pop-up window (that the user may scroll through), with the candidate contacts ordered in a select priority (e.g. highest to lowest).

At 310, the processor receives a selection through the user interface from the list of candidate contacts. The selection designates one or more of the candidate contacts. Additionally or alternatively, the processor may receive a separate entry (separate and distinct from a selection from the candidate contact list). For example, the user may choose to type/enter a complete destination device address, such as when the desired device address is not presented on the candidate contact list or an outdated device address is listed on the candidate contact list.

Optionally, the operation at 310 may be repeated multiple times, such as when a user selects multiple candidate contacts to use in connection with a single communications event (e.g. when sending a group text, when directing an email to multiple individuals and the like).

At 312, the processor completes the communications event, such as by completing entry of content for the CE, adding attachments to the CE, and the like.

FIGS. 4A-4C illustrate processes for determining proximity information for candidate contacts in accordance with various embodiments. The operations of FIGS. 4A-4C are carried out by one or more processors 204 of the device 110 in response to execution of program instructions, such as in the CM application 224, and/or other applications stored in the local storage medium 206. Additionally or alternatively, the operations of FIGS. 4A-4C may be carried out by the processors within one or more servers 112 in response to execution of program instructions, such as in the CM application 224 stored at the server, and/or other applications stored at the server.

FIG. 4A illustrates a process for determining proximity information based on addresses stored in connection with contacts in the contact list, as well as an address stored for the generating the CE user. At 402, the processor designates the stored address, corresponding to the present user, as reference position data (RTD). The address may represent a home or office address, as well as any other predetermined physical location manually entered by the user or automatically recorded in connection with a user account and/or device.

At 404, the processor accesses a contact list and identifies one or more contacts of interest for which proximity information is to be added or updated. As one example, the contacts of interest may represent the complete list of contacts on the contact list. Alternatively, the contact of interest may represent a subset of the complete contact list. The subset may be identified in various manners. For example, the subset may correspond to certain categories of contacts, such as business colleagues, personal contacts, family members, and the like. For example, when a user is preparing to go on vacation or is on vacation, the user may instruct the CM application 224 to update the proximity information for the user's family members and/or friends. As another example, when a user is preparing for, or is on, a business trip, the user may instruct the CM application 224 to update all or a subset of the user's business contacts. Additionally or alternatively, the device may automatically identify the contacts of interest, such as based on past behavior. For example, the contacts of interest may correspond to a predetermined number of the most recently used contacts. Optionally, when the operations of FIG. 4A are being performed on a weekend, the contacts of interest may be limited to family and/or friends. When the operations of FIG. 4A are performed on a weekday, the contacts of interest may be limited to business colleagues. Additionally or alternatively, various geographic and/or temporal information may be used to identify which contacts of interest are to be processed. For example, the contacts of interest may be identified as individuals having addresses in a common city or state as the stored address and/or present physical location of the user device. As another example, the contacts of interest may be identified as individuals with whom the present user has corresponded or otherwise interacted in some recent predetermined period of time (e.g. the last 30, 60, 90 days). Once the contacts of interest have been identified, the operations at 406-410 are iteratively repeated to add or modify proximity information in connection with each contact of interest.

At 406, the processor obtains the stored address of a present contact of interest and records the stored address as candidate position data (CPD). At 408, the processor then calculates proximity information based on the reference position data and candidate position data. For example, the proximity information may represent a physical distance between the RPD and CPD. Optionally, the proximity information may represent less specific information, such as a simple indication as to whether the RPD and CPD are within a common geographic boundary, such as in a common city, state, township and the like. As another example, the proximity information may represent a normalized scale indicative of whether the candidate position data is near or far from the reference position data (e.g. on a scale of 1 to 10, with a one being close and a 10 being distant). The processor saves the proximity information in connection with the present contact.

At 410, the processor determines whether additional contacts of interest have been identified for which proximity information is to be calculated and/or updated. When additional contacts exist, flow returns to 406 and the operations at 406 to 410 are repeated for each contact of interest. Otherwise the process of FIG. 4A ends.

The operations of FIG. 4A may be performed periodically and/or based on various criteria, such as when the user device changes physical location by a desired amount. For example, when a user device travels between different cities or geographic regions, the operations of FIG. 4A may be repeated. As another option, the user may instruct the CM application 224, through the user interface, to perform the operations of FIG. 4A. It is recognized that additional criteria may be used to trigger performance of the operations in FIG. 4A.

FIG. 4B illustrates a process for determining proximity information based on coordinates of at least the user device. At 412, the processor obtains coordinates (e.g. GPS coordinates) of the present location of the user device and utilizes the coordinates as reference position data (RPD). The coordinates may be manually entered by the user or automatically recorded by the user device.

At 414, the processor accesses a contact list and identifies one or more contacts of interest for which proximity information is to be added or updated. Various examples are discussed above in connection with FIG. 4A for determining the contacts of interest. Once the contacts of interest have been identified, the operations at 416-430 are iteratively repeated to add or modify proximity information in connection with each contact.

At 416, the processor identifies a basis for tracking a present location of a contact of interest. The basis for tracking the location of one or more devices associated with the contact of interest may represent direct and indirect tracking techniques.

At 418, the processor determines whether the basis for tracking location corresponds to a direct tracking technique between the user device and one or more contact-related devices. For example, a direct tracking technique may involve direct communication between the user device and contact-related devices, such as through a Bluetooth connection and/or other near field wireless communications medium. When direct communications are to be used, flow moves to 420. Otherwise, flow advances to 422

At 420, a transceiver performs a near field wireless communications session to search for a contact-related device associated with a contact of interest. For example, the transceiver may search for a contact-related device over a local Wi-Fi network, a Bluetooth link, a personal hotspot, or other near field wireless medium. When a corresponding contact-related device is identified, flow advances to 426.

At 422, the processor determines whether the basis for tracking the present location corresponds to an indirect tracking technique. For example, an indirect tracking technique may involve a user-related device conveying a position request to a contact-related device over a network. When indirect tracking is to be used, flow advances from 422 to 424. At 424, the processor of the user-related device conveys a location request over a network to the contact-related device, such as by directing the location request to an IP address or other network address saved in connection with the contact. The user-related device and contact-related device communicate with one another until the user-related device obtains sufficient information to identify a present location of the contact-related device. For example, the contact-related device may convey its present GPS coordinates to the user-related device, or convey less specific information, such as a general geographic region, network identification information and the like. Thereafter flow advances to 426.

At 426, the processor determines the current coordinates of the contact-related device, such as based on the results of the near field wireless search and/or information returned from the contact-related device over a network. The coordinates are saved as the candidate position data. At 428, the processor then calculates proximity information based on the reference position data and candidate position data. The processor saves the proximity information in connection with the present contact of interest. At 430, the processor determines whether additional contacts of interest exist for which proximity information is to be calculated and/or updated. When additional contacts exist, flow returns to 416. Otherwise the process of FIG. 4B ends.

FIG. 4C illustrates a process for determining proximity information based on correlation between calendar events for a user calendar and a contact-related calendar in accordance with embodiments herein. At 452, the processor identifies and designates one or more calendar events from a calendar, corresponding to the present user, as reference position data (RTD). The calendar event may represent a meeting notice, a trip or any other notation recorded in the electronic calendar for a user account associated with the present user. Optionally, the user may directly enter a calendar event to be used as the reference position data. A calendar event may be utilized as reference “position” data as the calendar event generally designates a particular activity that the user will participate in, and potentially a location of such activity.

At 454, the processor accesses a contact list and identifies one or more contacts of interest for which proximity information is to be added or updated. As one example, the contacts of interest may represent the complete list of contacts on the contact list. Alternatively, the contact of interest may represent a subset of the complete contact list. The subset may be identified in various manners. For example, the subset may correspond only to contacts for whom the present user has access to their electronic calendar. Additionally or alternatively, the subset of contacts may be identified based on individuals invited to the calendar event on the user's calendar. For example, a calendar event on a present user's calendar may include 10 invitees, all or some of which represent contacts in the contact list of the present user's account. Accordingly, the contact of interest identified, at 454, corresponds to the invitees to the user's calendar event. As another example, the contact of interest may be identified based on the nature or type of calendar event. For example, the calendar event may be designated as personal or vacation. Accordingly, the contact of interest may be limited to friends and family. As another example, the calendar event they be designated as a client meeting or management meeting. Accordingly, the contacts of interest may be limited to individuals who are similarly classified (e.g. individual contacts classified as clients, individual contacts classified as colleagues or managers, etc.).

At 456, the processor may search through a calendar associated with the present contact of interest for calendar events that are stored as candidate position data (CPD). A calendar event may be utilized as candidate “position” data as the calendar event generally designates a particular activity that the contact of interest will participate in, and potentially a location of such activity.

At 458, the processor then calculates proximity information based on the reference position data and candidate position data. For example, the proximity information may represent an indication that the present user and contact of interest are participating in a common calendar event. As another example, the proximity information may represent an indication that the present user and contact of interest are participating in entirely separate and independent calendar events. As another example, the proximity information may indicate that the contact of interest has been designated as a type of contact consistent with the type or nature of the user's calendar event (e.g. family vacation, management meeting, etc.). Optionally, the proximity information may represent a simple indication as to whether the RPD and CPD are within a common geographic boundary, such as in a common city, state, Township and the like. As another example, the proximity information may represent a normalized scale indicative of a correlation between the calendar events of the present user and candidate of interest (e.g. on a scale of 1 to 10, with a one being closely correlated and a 10 being uncorrelated). The processor saves the proximity information in connection with the present contact.

At 460, the processor determines whether additional contacts of interest have been identified for which proximity information is to be calculated and/or updated. When additional contacts exist, flow returns to 456. Otherwise the process of FIG. 4C ends.

The operations of FIG. 4C may be performed periodically and/or based on various criteria, such as when the reference user device changes physical location. For example, when a user device travels between different cities or geographic regions, the operations of FIG. 4C may be repeated. As another option, the user may instruct the CM application 224, through the user interface, to perform the operations of FIG. 4C. It is recognized that additional criteria they be used to trigger performance of the operations in FIG. 4C.

FIG. 5 illustrates a screenshot of an example for a communications event associated with an electronic mail message presented in accordance with an embodiment herein. The communications event is initiated by opening an email window 500, such as when a user desires to send an email. The email window 500 includes a header section 502 that may include command options, such as “file”, “message”, “insert”, “options”, “format text” and the like. The email window 500 also includes a destination “TO” field 504, a destination “CC” field 506, a “Subject” field 508, a main body region 510 for entering content, as well as other known standard regions. In accordance with embodiments herein, when the email window 500 is opened, the operations of FIG. 3 are implemented to identify an ordered list of candidate contacts, at least a portion of which are then presented for selection. In the example of FIG. 5, a pop-up window 512 is presented proximate the TO field 504, with the pop up window 512 presenting device addresses 514 associated with candidate contacts. The candidate contacts were identified based on proximity information.

For example, when a user is in a business meeting or on hold for a conference call, the user may desire to send an email message to one or more business colleagues who have not yet entered the meeting/call. Alternatively, following a business meeting, the user may desire to send a group email message to the meeting attendees. In accordance with the operations of FIGS. 3 and 4A-4C, embodiments herein determined that various business colleagues are in close proximity to the user. Embodiments herein present, in the pop up menu 612, email addresses for such business colleagues. The business colleagues may be assigned high priorities on the contact list based on physical location, address, calendar events or otherwise.

FIG. 6 illustrates a screenshot of an example of a communications event associated with a text message presented in accordance with an embodiment herein. The communications event is initiated by opening a text message window 600, such as when the user desires to send a text message. The text message window 600 includes a header section 602 that may include command options, such as “cancel” and the like. The text message window 600 also includes a “TO” field 604, a main body region 610 for entering content, as well as other known standard regions. In accordance with embodiments herein, when the text message window 600 is opened, the operations of FIG. 3 are implemented to identify an ordered list of candidate contacts, at least a portion of which are then presented for selection. In the example of FIG. 6, a pop-up window 612 is presented proximate the TO field 604, with the pop up window 612 presenting device phone numbers 614 associated with candidate contacts. The candidate contacts were identified based on proximity information.

For example, when a user is on vacation with a family, the user may desire to send a group text message to one or more family members. In accordance with the operations of FIGS. 3 and 4A-4C, embodiments herein determined that various family members are in close proximity to the user and thus present, in the pop up menu 612, phone numbers for such family members. The family members may be assigned high priorities on the contact list based on physical location, address, calendar events or otherwise.

In accordance with at least one embodiment herein, to the extent that devices are discussed herein, it should be understood that they can represent a very wide range of devices, applicable to a very wide range of settings. Thus, by way of illustrative and non-restrictive examples, such devices and/or settings can include mobile telephones, tablet computers, and other portable computers such as portable laptop computers.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the FIGS., which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying FIGS., it is to be understood that this description is not limiting and that various other changes and modifications may be affected therein by one skilled in the art without departing from the scope or spirit of the disclosure.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method, comprising:
under control of one or more processors configured with specific executable program instructions,
preparing a communications event (CE) through a user interface of a user-related device;
accessing proximity information related to contacts on a contact list; and
presenting, on the user interface of the user-related device, a candidate contact to utilize with the communications event based on the proximity information.

2. The method of claim 1, further comprising ordering a list of candidate contacts based on the proximity information, wherein the presenting includes presenting the list of candidate contacts in an ordered priority.

3. The method of claim 1, wherein the preparing includes opening a CE message having a destination field and the presenting includes displaying a list of device destination addresses associated with candidate contacts.

4. The method of claim 1, further comprising determining the proximity information based on a user-related location and a contact-related location.

5. The method of claim 4, wherein the user-related location is associated with a physical location of the user-related device and the contact-related location is associated with a physical location of a contact-related device.

6. The method of claim 4, wherein the determining includes determining a distance between the user-related location and the contact-related location.

7. The method of claim 1, wherein the communications event is associated with a user account, the contact list being associated with the user account.

8. The method of claim 7, further comprising determining the proximity information based on a user-related calendar event associated with the user account and a contact-related calendar event associated with the candidate contact.

9. The method of claim 1, further comprising tracking a contact-related location of the candidate contact and updating the proximity information based on the contact-related location.

10. A device, comprising:
a processor;
a user interface generated via the processor;
a memory storing program instructions accessible by the processor;
wherein the program instructions are executable by the processor to:
prepare a communications event (CE) through the user interface;
access proximity information related to contacts on a contact list; and
present, on the user interface, a candidate contact to utilize with the communications event based on the proximity information.

11. The device of claim 10, wherein the program instructions are executable by the processor to implement a proximity identifier module and a priority manager module, the proximity identifier module configured to determine when a contact-related location associated with one or more contacts on the contact list changes, the priority manager module configured to reduce a priority of the one or more candidate contacts based on the change.

12. The device of claim 10, wherein the program instructions are executable by the processor to implement a proximity identifier module, the proximity identifier module configured to determine the proximity information for candidate contacts that have associated contact-related calendar events that correspond to a user-related calendar event.

13. The device of claim 10, wherein the program instructions are executable by the processor to implement a priority manager module, the priority manager module configured to prioritize a list of candidate contacts by increasing a priority of one or more candidate contacts.

14. The device of claim 10, wherein the program instructions are executable by the processor to implement a CE manager module that is configured to initiate the communications event by opening a text or email application and to present a candidate phone or email address for the candidate contact.

15. The device of claim 10, wherein the program instructions are executable by the processor to implement a priority manager module configured to monitor past interaction with the candidate contact, and change a rank of the candidate contact based on the past interaction.

16. The device of claim 10, wherein the memory further stores a list of contacts, the contacts including corresponding proximity information and one or more candidate device destination addresses.

17. The device of claim 10, wherein the user interface is configured to display a CE message having a destination field and to display a list of device addresses associated with a list of candidate contacts, the user interface configured to receive a selection from the list of candidate contacts, the user interface populating the destination field with one or more device destination addresses based on the selection from the list of candidate contacts.

18. A computer program product comprising a non-signal computer readable storage medium comprising computer executable code to perform:
prepare a communications event (CE) through a user interface of a user-related device;
access proximity information related to contacts on a contact list; and
present, on the user interface of the user-related device, a candidate contact to utilize with the communications event based on the proximity information.

19. The computer program product of claim 18, further comprising determining the proximity information based on a user-related location and a contact-related location.

20. The computer program product of claim 18, further comprising determining the proximity information based on a user-related calendar event associated with the user account and a contact-related calendar event associated with the candidate contact.
